(19) United States
(12) Patent Application Publication
(10) Pub. No.: US 2026/0277550 A1
(43) Pub. Date: Sep. 17, 2026

(54) METHOD, APPARATUS, DEVICE AND STORAGE MEDIUM FOR TASK EXECUTION

(71) Applicants: Beijing Zitiao Network Technology Co., Ltd., Beijing (CN); Lemon Inc., Grand Cayman (KY)

(72) Inventors: Jun Ge, Beijing (CN); Yulin Deng, Beijing (CN); Hao Li, Hong Kong (CN); Peng Shi, Beijing (CN); Qing Wan, Beijing (CN); Yi Zhang, Los Angeles, CA (US); Hongrui Zhang, Los Angeles, CA (US); Lei Wang, Beijing (CN); Zhangyi Chen, Beijing (CN)

(21) Appl. No.: 19/479,714

(22) PCT Filed: May 20, 2024
(86) PCT No.: PCT/CN2024/094316

§ 371 Date: Oct. 28, 2025

(30) Foreign Application Priority Data
May 24, 2023 (CN) 202310594243.1

(51) Int. Cl. G06F 8/20

(52) U.S. Cl. CPC G06F 8/20

(57) ABSTRACT

According to embodiments of the present disclosure, a method, an apparatus, a device, and a storage medium for task execution are provided. In the method for task execution, a task to be executed is determined based on a user intent identified from a user input. A set of functional blocks is determined based on a plurality of functional blocks and a data flow associated with the task. The task is executed using the combined set of functional blocks. In this way, the user needs may be understood, and the indicated task may be conveniently and flexibly completed by combining the set of functional blocks.

The present application claims priority to Chinese Patent Application No. 202310594243.1, filed on May 24, 2023, and entitled “METHOD, APPARATUS, DEVICE, AND STORAGE MEDIUM FOR TASK EXECUTION”, which is incorporated herein by reference in its entirety.

### FIELD

Example embodiments of the present disclosure generally relate to the field of computer, and in particular, to a method, an apparatus, a device, and a computer-readable storage medium for task execution.

### BACKGROUND

With the development of computer technologies, various terminal devices can provide people with various services in work, life, and other aspects. For example, a general-purpose application that provides services may be deployed in a terminal device. An application creation platform may also be deployed in the terminal device. Such an application creation platform supports users to create applications that meet their own needs, for example, users can build interfaces, build databases, create corresponding processes, and perform operation and maintenance, etc.

### SUMMARY

In a first aspect of the present disclosure, a method for task execution is provided. The method includes: determining a task to be executed based on a user intent identified from a user input; determining a set of functional blocks based on a plurality of functional blocks and a data flow associated with the task; and executing the task using the combined set of functional blocks.

In a second aspect of the present disclosure, an apparatus for task execution is provided. The apparatus includes: a task determination module configured to determine a task to be executed based on a user intent identified from a user input; a functional block determination module configured to determine a set of functional blocks based on a plurality of functional blocks and a data flow associated with the task; and an execution module configured to execute the task using the combined set of functional blocks.

In a third aspect of the present disclosure, a device for task execution is provided. The device includes at least one processing unit; and at least one memory coupled to the at least one processing unit and storing instructions for execution by the at least one processing unit, the instructions, when executed by the at least one processing unit, causing the device to perform the method of the first aspect.

In a fourth aspect of the present disclosure, a computer-readable storage medium is provided. The computer-readable storage medium has a computer program stored thereon, and the computer program is executable by a processor to implement the method of the first aspect.

In a fifth aspect of the present disclosure, a method for task execution is provided. The method includes: determining a task to be executed based on a user intent identified from a user input; executing the task using a set of functional blocks provided by a low-code platform; and generating an application for executing the task based on the set of functional blocks in response to a preset condition being satisfied.

In a sixth aspect of the present disclosure, an apparatus for task execution is provided. The apparatus includes: a task determination module configured to determine a task to be executed based on a user intent identified from a user input; an execution module configured to execute the task using a set of functional blocks provided by a low-code platform; and a generation module configured to generate an application for executing the task based on the set of functional blocks in response to a preset condition being satisfied.

In a seventh aspect of the present disclosure, a device for task execution is provided. The device includes at least one processing unit; and at least one memory coupled to the at least one processing unit and storing instructions for execution by the at least one processing unit, the instructions, when executed by the at least one processing unit, causing the device to perform the method of the fifth aspect.

In an eighth aspect of the present disclosure, a computer-readable storage medium is provided. The computer-readable storage medium has a computer program stored thereon, and the computer program is executable by a processor to implement the method of the fifth aspect.

It should be understood that the content described in this section is not intended to limit the key features or important features of the embodiments of the present disclosure, nor is it intended to limit the scope of the present disclosure. Other features of the present disclosure will become readily understood through the following description.

### BRIEF DESCRIPTION OF DRAWINGS

The above and other features, advantages, and aspects of the embodiments of the present disclosure will become more apparent when taken in conjunction with the drawings and with reference to the following detailed description. In the drawings, the same or similar reference numerals refer to the same or similar elements, where:

FIG. 1 illustrates a schematic diagram of an example environment in which embodiments of the present disclosure can be implemented;

FIG. 2 illustrates a schematic diagram of an example architecture for task execution according to some embodiments of the present disclosure;

FIG. 3 illustrates a schematic diagram of an example for ticket booking task execution according to some embodiments of the present disclosure;

FIG. 4 illustrates a flowchart of a method for task execution according to some embodiments of the present disclosure;

FIG. 5 illustrates a block diagram of an apparatus for task execution according to some embodiments of the present disclosure;

FIG. 6 illustrates a flowchart of a method for task processing according to some embodiments of the present disclosure;

FIG. 7 illustrates a block diagram of an apparatus for task processing according to some embodiments of the present disclosure; and

FIG. 8 illustrates a block diagram of a device capable of implementing multiple embodiments of the present disclosure.

### DETAILED DESCRIPTION

The embodiments of the present disclosure will be described in more detail below with reference to the drawings. While certain embodiments of the present disclosure are shown in the drawings, it should be understood that the present disclosure may be implemented in various forms and should not be construed as limited to the embodiments set forth herein; rather, these embodiments are provided for a more thorough and complete understanding of the present disclosure. It should be understood that the drawings and embodiments of the present disclosure are only for illustrative purposes and are not intended to limit the scope of protection of the present disclosure.

In the description of the embodiments of the present disclosure, the term “include/comprise” and similar terms should be understood as open-ended inclusions, that is, “include/comprise but not limited to”. The term “based on” should be understood as “based, at least in part, on”. The term “one embodiment” or “the embodiment” should be understood as “at least one embodiment”. The term “some embodiments” should be understood as “at least some embodiments”. Other explicit and implicit definitions may also be included below.

In the present disclosure, unless explicitly stated, performing a step “in response to A” does not mean that the step is performed immediately after “A”, but may include one or more intermediate steps. It should be understood that the data involved in the technical solution of the present disclosure (including, but not limited to, the data itself, the acquisition, use, storage, or deletion of the data) should comply with the requirements of corresponding laws, regulations, and relevant provisions.

It should be understood that, before the technical solutions disclosed in the embodiments of the present disclosure are used, the type, use scope, use scenario, etc. of the information involved in the present disclosure should be informed to relevant users through appropriate means, and authorization from the relevant users should be obtained, in accordance with relevant laws and regulations. The relevant users may include any type of right holder, for example, an individual, an enterprise, a group, etc. For example, in response to receiving an active request from a user, prompt information is sent to the relevant user to explicitly prompt the relevant user that the operation requested to be performed will require acquisition and use of information of the relevant user, so that the relevant user can independently select, according to the prompt information, whether to provide the information to software or hardware, such as an application creation platform, an application, a server, or a storage medium, that performs an operation of the technical solution of the present disclosure.

As an optional but non-restrictive implementation, the manner of sending the prompt information to the relevant user in response to receiving the active request from the relevant user may be, for example, a pop-up window, and the prompt information may be presented in text in the pop-up window. In addition, the pop-up window may also carry a selection control for the user to select “agree” or “disagree” to provide information to the application creation platform.

It should be understood that the above process of notifying and obtaining user authorization is only illustrative, and does not constitute a limitation on implementations of the present disclosure. Other implementations that satisfy relevant laws and regulations may also be applied to implementations of the present disclosure.

As briefly mentioned above, developers can build, deploy, use, update, manage, and perform other operations on an application through an application creation platform according to requirements, and then provide users with applications that meet their needs. However, the capabilities of the application creation platform are limited, in other words such an application creation platform can only create applications. For those users who only care about the services that can be provided, but do not want to participate in creating applications, such application creation platforms cannot meet the long-tail needs of users in a more flexible and convenient manner. In addition, sometimes the specific needs of users may not be met by these created applications. Therefore, it is a current technical problem to be explored to provide users with applications that match their needs or directly perform tasks indicated by the needs.

Due to more accurate semantic understanding capabilities and context reasoning capabilities brought by a model, users can express user intents (for example, multimodal forms involving natural language can be used) and interact with applications, while the applications can interact with the model through a natural language interface. In this case, it is expected that applications can make fuller use of natural languages to make applications more flexible. It will be understood that in the context of the present disclosure, a “model” may be a machine learning model.

To this end, embodiments of the present disclosure provide a solution for task execution. According to various embodiments of the present disclosure, first, a task to be executed is determined based on a user intent identified from a user input. A set of functional blocks is determined based on a plurality of functional blocks and a data flow associated with the task. Then, the task is executed using a combined set of functional blocks.

According to the embodiments of the present disclosure, functional blocks required to satisfy user needs may be determined based on user intents identified from user inputs. According to the functionalities of respective functional blocks and the dependency relationships there behind, a call chain is automatically formed, and these functional blocks are combined to satisfy user needs. In this way, the user needs may be satisfied immediately and flexibly using the natural language interface.

The example embodiments of the present disclosure are described below with reference to the drawings.

FIG. 1 illustrates a schematic diagram of an example environment 100 in which embodiments of the present disclosure can be implemented. In the environment 100, an application creation platform 110 (for example, a platform implemented based on low-code technologies, also referred to as a low-code platform) may be used by a user 140 who expects to create and maintain an application, to create and maintain an application 150. In some embodiments, the application creation platform 110 may also be regarded as an application that provides application creation services. In some embodiments, the application creation platform 110 may be a platform based on application platform as a service (aPaas). The application creation platform 110 may understand an input from the user 140 by means of a model 120. In some embodiments, the application creation platform 110 may select appropriate functional blocks from a functional block library 130, and generate the application 150 based on some or all of the selected functional blocks.

In some embodiments, the application creation platform 110 may run a digital assistant 115. The digital assistant 115 may be integrated into the application creation platform 110 to be used for interacting with the user 140. The digital assistant 115 may also run independently outside the application creation platform 110. The digital assistant 115 may be invoked or awakened in an appropriate manner (for example, a shortcut key, a button, or voice), and then present an interaction window (for example, a chat window) with the user 140. Such a chat window may be presented in a client interface of the application creation platform 110. The chat window may include interface elements for information exchange, such as an input box, a message list, a message bubble, and the like. The digital assistant 115, as an intelligent assistant, has capabilities in intelligent conversation and information processing. The digital assistant 115 may receive a chat message input by the user 140 in the chat window, and provide a reply message. In some embodiments, the digital assistant 115 may be obtained based on a different model from the model 120.

The application creation platform 110 may run on an appropriate electronic device. In some embodiments, the functional block library 130 may be stored as part of the application creation platform 110. In some embodiments, the model 120 and the application creation platform 110 may run on different electronic devices.

The electronic device here may be any type of device with a computing capability, including a terminal device or a server device. The terminal device may be any type of mobile terminal, stationary terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an ebook device, a game device, or any combination thereof, including accessories and peripherals of these devices or any combination thereof. The server device may include, for example, a computing system/server, such as a mainframe, an edge computing node, a computing device in a cloud environment, and the like.

In some embodiments, the electronic device may run a client of the application creation platform 110, and the client may support interaction with the application creation platform 110. In the case where the application creation platform 110 runs on a terminal device of the user, the user 140 may interact with the application creation platform 110 by means of the client. In the case where the application creation platform 110 runs on a server device, the application creation platform 110 may implement the provisioning of services for the client running on the terminal device based on a communication connection between the server device and the terminal device.

It should be understood that the structure and function of the environment 100 are described for illustrative purposes only, without implying any limitation on the scope of the present disclosure.

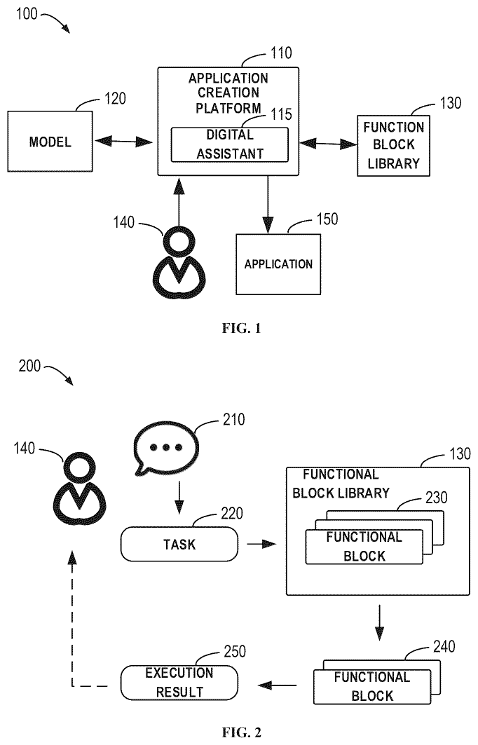

FIG. 2 illustrates a schematic diagram of an example architecture 200 for task execution according to some embodiments of the present disclosure. The example architecture 200 may be implemented in the environment 100. The example architecture 200 is described below with reference to FIG. 1.

According to an example implementation of the present disclosure, the user input may describe the user intent, and may involve a multimodal form. The multimodal form here may include, for example, at least any of the following: a text input, a voice input, an image input, and a video input that describe the user intent in a natural language. For ease of description, the process of task execution will be described below only by using examples of the user input represented in a natural language in text format.

In the example of FIG. 2, the application creation platform 110 receives a user input 210 represented in a natural language from the user 140. In this way, the immediacy and flexibility of task execution can be improved. Such a natural language may include text, voice, or a combination thereof. The application creation platform 110 may provide any suitable type of interface to receive the user input 210.

The user input 210 may indicate a task 220 to be executed. The task 220 may be determined by parsing the user input 210. In an example, the application creation platform 110 receives the user input 210 in a text form, for example, “Please book two cups of coffee for me”. After parsing the text, the application creation platform 110 determines that the task to be executed is “booking coffee”. In another example, the application creation platform 110 receives the user input 210 in a voice form, for example, the user 140 says “book a flight ticket to a certain place”. After parsing the voice, the application creation platform 110 determines that the task to be executed includes booking a flight ticket.

The task parsing described here may be performed by the application creation platform 110 itself, or may be performed by the application creation platform 110 using the model 120. In some embodiments, the application creation platform 110 may determine the task to be executed by means of the model 120. The model 120 is, for example, a language model. The application creation platform 110 may send the user input 210 to the model 120. It should be understood that any suitable language model may be used to determine the task to be executed based on the user input 210 represented in a natural language, and the present disclosure is not intended to limit the determination process.

The application creation platform 110 may determine a set of functional blocks 240 based on the data flow associated with the task and the plurality of functional blocks. The data flow associated with the task includes various data and a flow direction required to complete the task. As an example, the task is “generate an album for me and send it to me by email”. To complete this task, data such as materials (for example, individual images) required for generating the album and requirements for the album need to be provided to an album generation module, and the email address of the user needs to be provided to an email sending module. In addition, the generated album needs to be provided from the album generation module to the email sending module. For example, an upstream functional block, an intermediate functional block, a downstream functional blocks, and the like may be determined based on the data flow, and these functional blocks may be used as the set of functional blocks 240. Further, the application creation platform 110 may execute the task 220 using the combined set of functional blocks 240. In this way, various functional blocks may be flexibly combined to complete the user needs according to their own functionalities and a dependency relationship there behind.

In some embodiments, the set of functional blocks 240 may be determined from the functional block library 130 including a plurality of functional blocks 230. That is, these functional blocks 230 are provided by the functional block library 130. The plurality of functional blocks 230 may include applications and/or components in the applications. The application may include any type of application, including but not limited to office applications, tool applications, entertainment applications, shopping applications, social applications, and the like. Components may include, but are not limited to, an audio and video conference component, an email component, a calendar component, a schedule component, a payment component, a chat component, and the like. The components in the application are, for example, a calendar component in an office application, a voiceprint recognition component in a tool application, and the like. Each of the plurality of functional blocks 230 may be an application or a component in an application. Compared with the application, the component in the application is used to implement more detailed functionalities. Therefore, in these embodiments, these functional blocks may be used to implement functionalities with different levels of detail (also referred to as granularity). In this way, the selection and combination of functional blocks are more flexible to better meet the needs of users expressed in natural languages. Additionally or alternatively, the application creation platform 110 may store newly installed applications or components in the applications to the functional block library 130 to perform more diverse tasks.

In some embodiments, the application creation platform 110 may determine, from the plurality of functional blocks 230, functional blocks matching the task 220 based on respective description information of the plurality of functional blocks 230, and use them as at least part of the set of functional blocks 240. The description information of each functional block at least includes a semantic description of a functionality of the functional block. Such a semantic description is a form understandable by the model 120. The understandable form means that the language, format, or the like, of the text meets a preset requirement of the model 125. The description information may also indicate an input and an output of the functional block and requirements (for example, a format) for the input and output. In this way, the model 120 may select the functional blocks matching the task 220.

In some embodiments, the application creation platform 110 may send the user input 210 and the description information of the plurality of functional blocks 230 together to the model 120. The model 120 may determine the task 220 to be executed based on semantic analysis of the user input 210, and determine functionalities of respective functional blocks according to the semantic analysis of the description information, so that the functional blocks for executing the task may be selected.

In some embodiments, the application creation platform 110 may generate a prompt input based on the respective description information of the plurality of functional blocks 230 and the user input 210. Such prompt input is also referred to as a prompt, a guide word, or the like to the model. Further, the application creation platform 110 provides the respective description information of the plurality of functional blocks 230, the user input 210, and the prompt input together to the model 120. The model 120 may better understand the user input 210 based on the prompt input, so as to select more appropriate functional blocks matching the task 220. The application creation platform 110 obtains an indicator of the functional blocks matching the task 220 from the model 120. That is, the model 120 may indicate or notify the determined functional blocks to the application creation platform 110, so that the application creation platform 110 can subsequently combine them.

In some embodiments, the application creation platform 110 may receive the user input 210 and interact with the user 140 through the digital assistant 115. The digital assistant 115 may be a model-based assistant. The digital assistant 115 has intelligent conversation and information processing capabilities (such as processing text, voice, image, or video). For example, in a chat window between the user 140 and the digital assistant 115, the user 140 may input a chat message, and the digital assistant 115 may provide a reply message or option information for the user 140 to select in response to the chat message. In this way, the user may be provided with a convenient interface for expressing and clarifying needs.

As an example, for the task of “booking coffee”, the digital assistant 115 receives a chat message “Please book two cups of coffee for me” sent by the user 140. To further clarify the user needs, the digital assistant 115 sends a question “Which store/brand of coffee do you want to book?” to the user 140. After receiving a reply message from the user 140, the application creation platform 110 may provide all chat messages or processed chat messages to the model 120.

As another example, the user 140 says “I want to borrow a book from the library”. After analyzing the voice, the application creation platform 110 determines that the user needs are “borrowing a book”. To further clarify the user needs, the digital assistant 115 may present a list of new books in the chat window. The digital assistant 115 may present information such as a cover, a preface, and a trial chapter of the book after receiving a trigger (for example, an click on a certain book) from the user 140. The digital assistant 115 may also provide the information together to the model 120 after receiving a confirmation from the user 140 (for example, the user 140 says “borrow this book for me”).

Alternatively or additionally, the above-described clarification or explicitness of the needs may also be implemented by the application creation platform 110 using the model 120.

In some embodiments, the application creation platform 110 may interact with the user 140 (for example, through the digital assistant 115) during the process of parsing or executing the task 220. The interactive information may be in a format of text, image, audio, video, or any other appropriate format. For example, for the task of “booking a flight ticket”, the application creation platform 110 queries a plurality of pieces of matching flight information through a functional block that supports flight ticket booking. Further, the application creation platform 110 may send the flight information to the user 140 in a text format through the digital assistant 115 for the user 140 to make a selection.

In some embodiments, the application creation platform 110 may generate a policy or assistance information based on the user input 210 and provide it to the model 120. Such a policy or assistance information is used at least to guide the model 120 to understand the user input 210 and select the functional blocks. Considering that the model 120 may be a general-purpose model, and it may not be able to determine an information processing policy in a specific field or a specific scenario, by providing such a policy or assistance information to the model 120, the model 120 may be helped to perform analysis and processing according to the preset policy, so that the determined task to be executed and the selected functional blocks are more satisfactory to the expectation.

In some embodiments, the functional blocks matching the task 220 may include a plurality of candidate modules for executing at least part of the task. These candidate modules at least in part implement same or similar functionalities. For example, these candidate modules can all implement flight ticket booking. In this case, the application creation platform 110 may provide an indication of these candidate modules to the user 140. The user may select a target candidate module from these candidate modules. The application creation platform 110 may remove other candidate modules than the target candidate module based on the selection of the target candidate module by the user 140. In this way, the task may be performed efficiently in a manner that better meets the expectation of the user.

In some scenarios, when the application creation platform 110 analyzes the user input and selects the functional blocks through the model 120, the model 120 may split the task 220 into multiple sub-tasks. When selecting the functional blocks based on these sub-tasks and the description information of the plurality of functional blocks 230, the model 120 may give feedback that there are no functional blocks that can be used to execute a certain sub-task or some sub-tasks. In some embodiments, in response to such feedback, the application creation platform 110 may create functional blocks for executing such sub-tasks by rewriting a functional block in the plurality of functional blocks 230. Additionally or alternatively, the application creation platform 110 may create a new functional block. For example, an existing functional block may be split into functional blocks with smaller granularity, or a new functional block may be recreated. In this way, the user needs may be fulfilled as much as possible. The rewritten functional block and/or the newly created functional block may be combined with the functional block selected from the functional block library 130 to execute the task 220.

Examples of combining the set of functional blocks 240 are described below. In some embodiments, the application creation platform 110 may determine an execution order of the set of functional blocks 240 based on the data flow associated with the task 220, and combine the set of functional blocks 240 according to the execution order. Such a data flow may include data transmitted between respective functional blocks. The application creation platform 110 may sequentially combine the set of functional blocks 240 according to a flow direction of data. Such a sequential combination may be, for example, in a serial, parallel, or at least partially parallel manner.

In some embodiments, the application creation platform 110 may determine an endpoint functional block in the set of functional blocks 240 based on endpoint data in the data flow associated with the task 220. Such endpoint data may include input data, output data, or a combination of the input data and the output data in the data flow. Such an endpoint functional block may include a start module, an end module, or both in the set of functional blocks 240. The application creation platform 110 may determine the start module based on the input data, and may also determine the end module based on the output data. Continuing with the example task of “booking a flight ticket”, the input data may include user information (for example, information of “Me”), and the output data may include information of the booked flight ticket. The application creation platform 110 may select a functional block that identifies the user identity (which is the start module in this example) based on the input data, and select a functional block that supports flight ticket booking (which is the end module in this example) based on the output data.

As another example, for the task of “booking coffee”, the input data may include parameter information such as a type of the coffee, a cup size, hot or cold, and may also include information such as a delivery address and a payment account. The output data may include coffee order information. Based on such an endpoint data flow, the application creation platform 110 may determine, from the plurality of functional blocks 230, a functional block that supports coffee takeout, a functional block that stores user preferences, a functional block that includes stored payment account information, and the like. In some scenarios, the application creation platform 110 determines, from the plurality of functional blocks 230, a plurality of functional blocks that support coffee takeout. The application creation platform 110 may use these functional blocks as candidate modules and send options to the user 140. Based on a selection of the user 140, the application creation platform 110 determines a set of functional blocks for executing the task of “booking coffee”.

The application creation platform 110 may perform semantic analysis on the user input 210 in a text form through the model 120 (for example, a language model). In some embodiments, the application creation platform 110 may select a natural language recognition module from the plurality of functional blocks 230 to parse the user input 210 to assist the model 120 in determining the task 220 to be executed. Such a language recognition module includes but is not limited to a voiceprint recognition module, a speech recognition module, a facial expression recognition (for example, mouth shape recognition, eye tracking) module, a gesture recognition module, and the like.

In some embodiments, the application creation platform 110 determines, from the set of functional blocks 240, an adjacent functional block adjacent to the endpoint functional block based on the interface data of the endpoint functional block. The endpoint functional block and the adjacent functional block may communicate via the interface data. Such an adjacent functional block may include a predecessor module and/or a successor module of the endpoint functional block. The interface data may include input interface data and/or output interface data.

Continuing with the example task of “booking a flight ticket”, the application creation platform 110 selects a functional block that supports flight ticket booking based on the output data. The input interface data of the endpoint functional block may include user information, invoice information, and payment account information. Further, the application creation platform 110 selects predecessor modules based on the interface data, for example, a functional block that stores user information (such as a name, an identification number, etc.), a functional block that stores invoice information, and a functional block that stores a payment account. The output interface data of the endpoint functional block may include outputting invoices, flight tickets, and the like. The application creation platform 110 selects successor modules based on such interface data, for example, a functional block that supports sending a text message to the user 140, a functional block that supports sending a picture to the user 140, and the like.

Additionally or alternatively, the application creation platform 110 selects a feedback module from the plurality of functional blocks 230 to send an execution result 250 to the user 140. The feedback module includes but is not limited to a calendar module, a schedule module, and the like. For example, the application creation platform 110 may add a flight itinerary as a task reminder through the calendar module. Additionally or alternatively, the application creation platform 110 may directly send the execution result 250 to the user 140. For example, the application creation platform 110 announces in voice that the flight ticket is successfully booked and detailed booking information.

The application creation platform 110 may select the set of functional blocks 240 from the plurality of functional blocks 230. Such set of functional blocks 240 may include a plurality of adjacent functional blocks, for example, an adjacent first functional block and an adjacent second functional block. In some embodiments, if the application creation platform 110 determines that the format of the output data of the first functional block is consistent with the format of the input data of the second functional block, the application creation platform 110 may combine the two functional blocks. For example, in the example task of “booking a flight ticket”, the first functional block is a voiceprint recognition module that can identify the identity of the user 140, thereby outputting the name of the user in a text format. The second functional block is a functional block that supports flight ticket booking, and can receive the name of the user in a text format and select added certificate information, thereby outputting the booked flight information. In this way, the application creation platform 110 can directly combine the two matched functional blocks.

In some embodiments, the combined first functional block and second functional block may be added to a cache of the functional block library including the plurality of functional blocks to form a third functional block. Here, input data of the formed third functional block is the same as the input data of the first functional block, and output data of the third functional block is the same as the input data of the second functional block. In other words, a temporary functional block generated using existing functional blocks may be stored in the cache, and the temporary functional block may be used as a basis for subsequent combination of functionalities. At this time, the temporary functional module may implement more complex functionalities, and the temporary functional block may be combined with other functional blocks in the functional block library. In some embodiments, the cache may be updated periodically, for example, when a certain temporary functional block has not been used for a long time (for example, more than one month or other time period), the temporary functional block is deleted. For another example, if a certain temporary functional block is frequently used subsequently, the temporary functional block may be moved from the cache to the functional block library.

In some scenarios, the first format of the output data of the first functional block is inconsistent with the second format of the input data of the second functional block. In some embodiments, the application creation platform 110 first uses a conversion module to convert data in the first format to data in the second format, and then combines the first functional block, the conversion module, and the second functional block. For example, in the example task of “borrowing a book”, the first functional block is a functional block that stores the library card of the user 140, and its output data is a library card in a picture format. The second functional block is a functional block that supports book borrowing, and its input data is an identification number in a text format. In this way, the application creation platform 110 may use the format conversion module to convert the output data in the picture format to the input data in the text format, thereby combining the two functional blocks using the format conversion module.

In some embodiments, the application creation platform 110 uses a functional block customized based on the first format and the second format as the conversion module. Additionally or alternatively, the application creation platform 110 obtains a third-party functional block based on the first format and the second format and uses it as the conversion module.

In some embodiments, the application creation platform 110 may add the conversion module to the plurality of functional blocks 230. For example, the format conversion module described above is stored in the functional block library 130, so that it can be directly selected and combined with other functional blocks when needed.

In some embodiments, the combined set of functional blocks 240 may be used to execute other tasks. For example, the application creation platform 110 may receive another user input represented in a natural language from a user (which may be another user different from the user 140), and determine another task to be executed by parsing the another user input. Further, the application creation platform 110 continues executing the another task using the combined set of functional blocks 240 in response to determining that the another task is of a same type as a previously executed task. In this way, an efficiency of task execution may be improved. For example, after completing the task of “booking a flight ticket” for the user A using the set of functional blocks 240, the application creation platform 110 receives the task of “booking a flight ticket” from the user B. The application creation platform 110 may continue to use the set of functional blocks 240 to perform the task of “booking a flight ticket” for the user B, without re-selecting functional blocks from the plurality of functional blocks 230 and combining them.

In some embodiments, the application creation platform 110 generates an application using the combined set of functional blocks 240, and stores the application, for example, by adding it to the functional block library 130. That is, such an application may be added to the plurality of functional blocks 230 as a functional block with larger granularity. Such an application may also directly provide services to the user 140 as other general-purpose applications. Additionally or alternatively, the user 140 may update, manage, run, maintain, etc. the generated application through the application creation platform 110.

In some embodiments, the task may be executed by directly using the combined set of functional blocks, without generating a new application. Alternatively and/or additionally, a new application may be generated by using the combined set of functional blocks, and the new application may be added to the functional block library so that the new application is used as another functional block, in which case the number of functional blocks in the functional block library may change.

In some embodiments, whether to generate the application using the combined set of functional blocks may be determined based on whether a preset condition is satisfied. Here, the preset condition may involve multiple aspects such as a number of executions of the task, an execution frequency of the task, and whether a generation instruction is received. For example, the application creation platform 110 accumulates a number of executions associated with a certain type of task 220. When the application creation platform 110 determines that the number of executions of the type of task exceeds a threshold number, the application creation platform 110 generates an application for executing the type of task using the combined set of functional blocks 240. Alternatively and/or additionally, the application creation platform 110 accumulates an execution frequency associated with a certain type of task 220. When the application creation platform 110 determines that the execution frequency exceeds a threshold frequency (for example, three times per week, and/or other values), the application creation platform 110 generates an application using the combined set of functional blocks 240. Alternatively and/or additionally, the application may be generated by using the combined set of functional blocks 240 in response to receiving a generation instruction (for example, a generation instruction input by the user, and/or a generation instruction set in the application creation platform 110). In this way, tasks with high execution frequencies may be efficiently handled.

In conclusion, according to the various embodiments of the present disclosure, the application creation platform 110 may analyze the user input 210 using the model 120 to determine the task 220, and may also determine the set of functional blocks 240 that can execute the task 220 based on the description information of the plurality of functional blocks 230. The application creation platform 110 may directly execute a temporary task by combining the set of functional blocks 240 according to an order, or may generate an application for execution of the same type of task at any time when needed. Further, the application creation platform 110 may improve the immediacy, flexibility, and comprehensiveness of task execution by adjusting the functional blocks, creating new functional blocks, or adding the generated application to the functional block library.

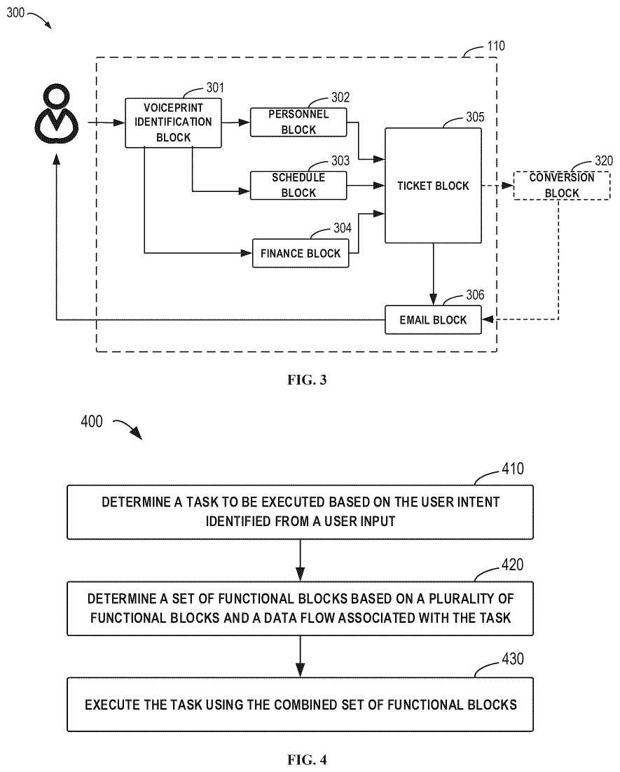

For more clearly understand the task execution scheme of the present disclosure embodiments, a specific example is described below with reference to FIG. 3. FIG. 3 illustrates a schematic diagram of an example 300 of booking a ticket according to some embodiments of the present disclosure. The example 300 is, for example, an office scenario where a plurality of users may share the application creation platform 110. The example 300 may be implemented in the environment 100. The example 300 is described below with reference to FIG. 3.

For example, the user A says “book a flight ticket to a certain place”. The application creation platform 110 receives the voice input of the user A, and sends the voice input and the description information of respective functional blocks in the functional block library 130 to the model 120. The model 120 or the application creation platform 110 may perform semantic analysis on the voice input or convert the voice input into text and then perform semantic analysis, to determine that the task to be executed is “booking a flight ticket”. The data flow associated with the task may include user information, invoice information, payment account information, and the like. Based on such a data flow, the model 120 determines the functionalities of respective functional blocks according to semantic analysis of the description information, so that the functional blocks for executing the task may be selected. For example, the model 120 analyzes that the input data is “I” in a voice form, and thus selects a voiceprint recognition module 301 (for example, as a start module) to determine user information, such as a name, an identification number, and the like. The model 120 analyzes that the output data is “flight ticket”, and thus selects a ticket module 305 (for example, as an end module) to book a flight ticket. After determining the start module and the end module, the model 120 continues to analyze the data flow or the description information to determine the adjacent functional blocks. For example, the ticket module 305 needs data such as the user name, the identification number, a destination, a travel date, the payment account, and the like. In this way, the model 120 selects a personnel module 302, a schedule module 303, and a finance module 304 as predecessor modules, and selects an email module 306 as a successor module.

Further, the application creation platform 110 receives the selection of the above functional blocks from the model 120 and combines them in sequence to execute the task of “booking a flight ticket”. In the process of executing the task, the voiceprint recognition module 301 processes the voice input to output identification information of the user (for example, the name, an employee number, etc.). The personnel module 302 receives the identification information of the user and outputs the identification number of the user and the name of the user. The schedule module 303 receives the name of the user and outputs the destination and the travel date. The finance module 304 receives the name of the user and outputs the payment account, invoice information, and the like. The ticket module 305 receives the above information and outputs an electronic flight ticket. The email module 306 receives the electronic flight ticket and outputs an email including flight information. In this way, the task of booking a flight ticket for the user A is completed through the combination of a set of functional blocks.

Further, the application creation platform 110 receives a task of another user B who also requests to book a flight ticket. The application creation platform 110 may use the combination of functional blocks described above or a stored application to perform the task of booking a flight ticket for the user B again.

In some scenarios, if the model 120 analyzes that the output data format of the ticket module 305 is inconsistent with the input data format of the email module 306, the model 120 may also select a conversion module 320 for data format conversion. In this way, the application creation platform 110 may combine the above functional blocks using the conversion module 320.

FIG. 4 illustrates a flowchart of a method 400 for task execution according to some embodiments of the present disclosure. The method 400 may be implemented at an electronic device running the application creation platform 110. The method 400 is described below with reference to FIG. 1.

At block 410, a task to be executed is determined based on a user intent identified from a user input. At block 420, a set of functional blocks is determined based on a plurality of functional blocks and a data flow associated with the task. At block 430, the task is executed using the combined set of functional blocks.

In some embodiments, functional blocks matching the task may also be determined from the plurality of functional blocks as at least part of the set of functional blocks based on respective description information of the plurality of functional blocks, the description information of a functional block at least including a semantic description of the functionality of the functional block.

In some embodiments, a prompt input may also be generated based on the respective description information of the plurality of functional blocks and the user input; the prompt input is provided to a model; and an indicator of the functional blocks matching the task is obtained from the model.

In some embodiments, the method 400 further includes: providing, in response to determining that the functional blocks matching the task comprise a plurality of candidate modules for executing at least part of the task, prompt of the plurality of candidate modules to the user; and removing, from the functional blocks matching the task, candidate modules other than a target candidate module based on a selection of the target candidate module by the user from the plurality of candidate modules.

In some embodiments, the method 400 further includes: determining an order of the set of functional blocks based on the data flow; and combining the set of functional blocks according to the order.

In some embodiments, an endpoint functional block of the set of functional blocks may also be determined based on endpoint data in the data flow, the endpoint data including at least any of the following in the data flow: input data, output data, and the endpoint functional block including at least any of the following in the set of functional blocks: a start module, an end module.

In some embodiments, an adjacent functional block adjacent to the endpoint functional block may also be determined from the set of functional blocks based on the interface data of the endpoint functional block, the endpoint functional block and the adjacent functional block communicate via the interface data, and the adjacent functional block includes at least any of the following of the endpoint functional block: a predecessor module, a successor module.

In some embodiments, for a first functional block and a second functional block in the set of functional blocks, the first functional block and the second functional block may also be combined in response to determining that a first format of output data of the first functional block is consistent with a second format of input data of the second functional block, and the first functional block and the second functional block are adjacent functional blocks arranged in the order.

In some embodiments, the method 400 further includes: adding the combined first functional block and second functional block to a cache of a functional block library comprising the plurality of functional blocks to form a third functional block, input data of the third functional block being the same as the input data of the first functional block, and output data of the third functional block being the same as the input data of the second functional block.

In some embodiments, the method 400 further includes: in response to determining that the first format and the second format are inconsistent, converting the first format to the second format using a conversion module; and combining the first functional block, the conversion module, and the second functional block.

In some embodiments, the method 400 further includes: adding the conversion module to a functional block library comprising the plurality of functional blocks.

In some embodiments, the conversion module is obtained based on at least any of the following: a functional block customized based on the first format and the second format; a third-party functional block obtained based on the first format and the second format.

In some embodiments, the method 400 further includes: creating, in response to determining that the plurality of functional blocks cannot execute at least part of the task, a functional block for executing the at least part of the task based on at least any of the following: rewriting a functional block in the plurality of functional blocks; and creating a new functional block different from the plurality of functional blocks.

In some embodiments, the method 400 further includes: receiving another user input represented in a natural language from a user; parsing the another user input to determine another task to be executed; and executing, in response to determining that the task and the another task are of a same type, the another task using the combined set of functional blocks.

In some embodiments, the method 400 further includes: generating an application using the combined set of functional blocks; and adding the application to a functional block library including the plurality of functional blocks.

In some embodiments, the application may be generated in response to determining that received user inputs associated with a type of the task satisfy a threshold condition.

In some embodiments, the method 400 further includes: determining that the user inputs satisfy the threshold condition in response to at least any of the following: a number of the user inputs exceeds a threshold number; a frequency of the user inputs exceeds a threshold frequency.

In some embodiments, the plurality of functional blocks are provided by the functional block library and include at least any of the following: an application, a component in the application.

In some embodiments, the user input includes a multimodal form, and the multimodal form includes at least any of the following: a text input, a voice input, an image input, and a video input that describe the user intent in a natural language.

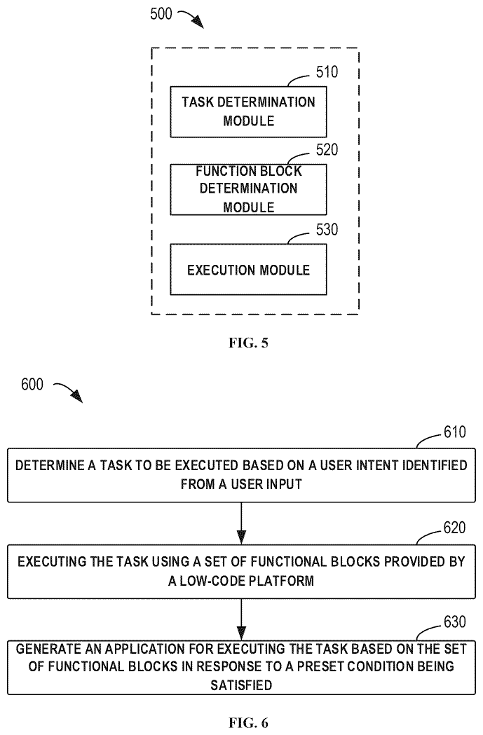

FIG. 5 illustrates a schematic structural block diagram of an apparatus 500 for task execution according to some embodiments of the present disclosure. The apparatus 500 may be implemented in or included in an electronic device running the application creation platform 110. Respective modules/components in the apparatus 500 may be implemented by hardware, software, firmware, or any combination thereof.

As shown in the figure, the apparatus 500 includes a task determination module 510 configured to determine a task to be executed based on a user intent identified from a user input. The apparatus 500 also includes a functional block determination module 520 configured to determine a set of functional blocks based on a plurality of functional blocks and a data flow associated with the task. The apparatus 500 also includes an execution module 530 configured to execute the task using the combined set of functional blocks.

In some embodiments, the functional block determination module 510 is configured to determine, from the plurality of functional blocks, functional blocks matching the task as at least part of the set of functional blocks based on description information of the plurality of functional blocks, the description information of each functional block at least including a semantic description of the functionality of the functional block.

In some embodiments, the functional block determination module 510 is further configured to generate a prompt input based on the respective description information of the plurality of functional blocks and the user input; provide the prompt input to a model; and obtain an indicator of the functional blocks matching the task from the model.

In some embodiments, the apparatus 500 further includes a providing module configured to provide, in response to determining that the functional blocks matching the task comprise a plurality of candidate modules for executing at least part of the task, prompt of the plurality of candidate modules to the user; and a removing module configured to remove, from the functional blocks matching the task, candidate modules other than a target candidate module based on a selection of the target candidate module by the user from the plurality of candidate modules.

In some embodiments, the apparatus 500 further includes an order determination module configured to determine an order of the set of functional blocks based on the data flow; and a combining module configured to combine the set of functional blocks according to the order.

In some embodiments, the order determination module is further configured to determine an endpoint functional block of the set of functional blocks based on endpoint data in the data flow, the endpoint data comprising at least one of the following in the data flow: input data, output data, and the endpoint functional block comprising at least any of the following in the set of functional blocks: a start module, an end module.

In some embodiments, the order determination module is further configured to determine, from the set of functional blocks, an adjacent functional block adjacent to the endpoint functional block based on the interface data of the endpoint functional block, the endpoint functional block and the adjacent functional block communicate via the interface data, and the adjacent functional block comprises at least one of the following of the endpoint functional block: a predecessor module, a successor module.

In some embodiments, the combining module is further configured to combine a first functional block and a second functional block in the set of functional blocks in response to determining that a first format of output data of the first functional block is consistent with a second format of input data of the second functional block, the first functional block and the second functional block being adjacent functional blocks arranged in the order.

In some embodiments, the apparatus 500 further includes an adding module configured to add the combined first functional block and second functional block to a cache of a functional block library comprising the plurality of functional blocks to form a third functional block, input data of the third functional block being the same as the input data of the first functional block, and output data of the third functional block being the same as the input data of the second functional block.

In some embodiments, the apparatus 500 further includes a format conversion module configured to, in response to determining that the first format and the second format are inconsistent, convert the first format to the second format using a conversion module; and a second combining module configured to in response to determining that the first format and the second format are inconsistent, combine the first functional block, the conversion module, and the second functional block.

In some embodiments, the apparatus 500 further includes an adding module configured to add the conversion module to the functional block library including the plurality of functional blocks.

In some embodiments, the conversion module is obtained based on at least any of the following: a functional block customized based on the first format and the second format; a third-party functional block obtained based on the first format and the second format.

In some embodiments, the apparatus 500 further includes a creating module configured to, in response to determining that the plurality of functional blocks cannot execute at least part of the task, create a functional block for executing the at least part of the task based on at least any of the following: rewriting a functional block in the plurality of functional blocks; and creating a new functional block different from the plurality of functional blocks.

In some embodiments, the apparatus 500 further includes a second receiving module configured to receive another user input represented in a natural language from a user; a parsing module configured to parse the another user input to determine another task to be executed; and a second execution module configured to, in response to determining that the task and the another task are of a same type, execute the another task using the combined set of functional blocks.

In some embodiments, the apparatus 500 further includes a generation module configured to generate an application using the combined set of functional blocks; and a second adding module configured to add the application to the functional block library including the plurality of functional blocks.

In some embodiments, the generation module is further configured to generate the application in response to determining that the received user inputs associated with the type of the task satisfy a threshold condition.

In some embodiments, the generation module is further configured to determine that the user inputs satisfy the threshold condition in response to at least any of the following: a number of the user inputs exceeds a threshold number; a frequency of the user inputs exceeds a threshold frequency.

In some embodiments, the plurality of functional blocks are provided by the functional block library and include at least any of the following: an application, a component in the application.

In some embodiments, the user input includes multimodal forms, and the multimodal forms include at least any of the following: a text input, a voice input, an image input, and a video input that describe the user intent in a natural language.

FIG. 6 illustrates a flowchart of a method 600 for task processing according to some embodiments of the present disclosure. At block 610, a task to be executed is determined based on a user intent identified from a user input. At block 620, the task is executed using a set of functional blocks provided by a low-code platform. At block 630, an application for executing the task is generated based on the set of functional blocks in response to a preset condition being satisfied.

In some embodiments, the method 600 further includes determining that the preset condition is satisfied in response to at least any of the following: a number of executions of the task exceeds a threshold number; a frequency of executions of the task exceeds a threshold frequency; an application generation instruction is received from a user.

In some embodiments, the method 600 further includes: adding the application to a functional block library including the plurality of functional blocks.

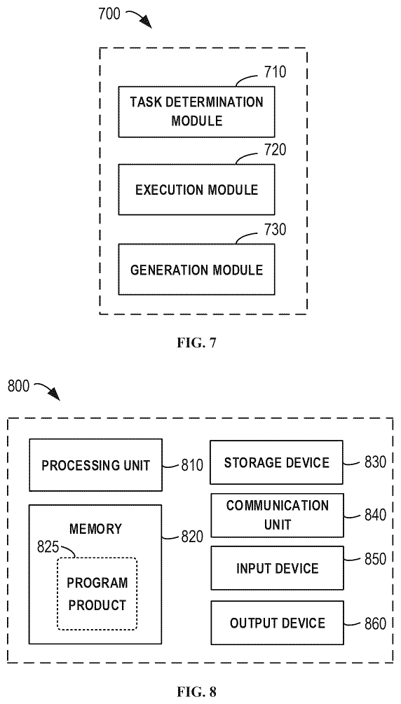

FIG. 7 illustrates a block diagram of an apparatus 700 for task processing according to some embodiments of the present disclosure. As shown in FIG. 7, the apparatus 700 includes: a task determination module 710 configured to determine a task to be executed based on a user intent identified from a user input; an execution module 720 configured to execute the task using a set of functional blocks provided by a low-code platform; and a generation module 730 configured to generate an application for executing the task based on the set of functional blocks in response to a preset condition being satisfied.

In some embodiments, the generation module 730 is further configured to determine that the preset condition is satisfied in response to at least any of the following: a number of executions of the task exceeds a threshold number; a frequency of executions of the task exceeds a threshold frequency; an application generation instruction is received from a user.

In some embodiments, the apparatus 700 further includes: an adding module configured to add the application to a functional block library including the plurality of functional blocks.

FIG. 8 illustrates a block diagram of an electronic device 800 in which one or more embodiments of the present disclosure may be implemented. It should be understood that the electronic device 800 shown in FIG. 8 is merely exemplary, and should not constitute any limitation on the functionalities and scope of the embodiments described herein. The electronic device 800 shown in FIG. 8 may be used to run the application creation platform 110 of FIG. 1.

As shown in FIG. 8, the electronic device 800 is in the form of a general-purpose application creation platform. Components of the electronic device 800 may include, but are not limited to, one or more processors or processing units 810, a memory 820, a storage device 830, one or more communication units 840, one or more input devices 850, and one or more output devices 860. The processing unit 810 may be an actual or virtual processor and may perform various processing according to programs stored in the memory 820. In a multiprocessor system, multiple processing units execute computer executable instructions in parallel to improve the parallel processing capability of the electronic device 800.

The electronic device 800 typically includes multiple computer storage media. Such media may be any available media accessible by the electronic device 800, including but not limited to volatile and non-volatile media, removable and non-removable media. The memory 820 may be a volatile memory (for example, a register, a cache, a random access memory (RAM)), a non-volatile memory (for example, a read-only memory (ROM), an electrically erasable programmable read-only memory (EEPROM), a flash memory), or some combination thereof. The storage device 830 may be a removable or non-removable medium and may include a machine-readable medium, such as a flash drive, a disk, or any other medium that can be used to store information and/or data and that can be accessed within the electronic device 800.

The electronic device 800 may further include additional removable/non-removable, volatile/non-volatile storage media. Although not shown in FIG. 8, a disk drive for reading from or writing to a removable, non-volatile disk (for example, a “floppy disk”) and an optical disk drive for reading from or writing to a removable, non-volatile optical disk can be provided. In these cases, each drive may be connected to a bus (not shown) by one or more data medium interfaces. The memory 820 may include a computer program product 825 having one or more program modules configured to perform various methods or actions of various embodiments of the present disclosure.

The communication unit 840 implements communication with other application creation platforms over a communication medium. Additionally, the functionality of the components of the electronic device 800 may be implemented in a single computing cluster or multiple computing machines that can communicate over communication connections. Thus, the electronic device 800 may operate in a networked environment using logical connections to one or more other servers, network personal computers (PCs), or another network node.

The input device 850 may be one or more input devices, such as a mouse, a keyboard, a trackball, and the like. The output device 860 may be one or more output devices, such as a display, a speaker, a printer, and the like. The electronic device 800 may also communicate, as needed, with one or more external devices (not shown), such as a storage device, a display device, etc., communicate with one or more devices that enable a user to interact with the electronic device 800, or communicate with any device (e.g., network card, modem, etc.) that enables the electronic device 800 to communicate with one or more other application creation platforms, through the communication unit 840. Such communication may be performed via an input/output (I/O) interface (not shown).

According to an example implementation of the present disclosure, there is provided a computer-readable storage medium having computer-executable instructions stored thereon, where the computer-executable instructions, when executed by a processor, implement the method described above. According to an example implementation of the present disclosure, there is further provided a computer program product tangibly stored on a non-transitory computer-readable medium and including computer-executable instructions, and the computer-executable instructions, when executed by a processor, implement the method described above.

Various aspects of the present disclosure are described herein with reference to flowcharts and/or block diagrams of methods, apparatuses, devices, and computer program products implemented according to the present disclosure. It should be understood that each block of the flowcharts and/or block diagrams and combinations of blocks in the flowcharts and/or block diagrams may be implemented by computer-readable program instructions.

These computer-readable program instructions may be provided to a processing unit of a general-purpose computer, a special-purpose computer, or other programmable data processing apparatus, to produce a machine, so that the instructions, when executed by the processing unit of the computer or other programmable data processing apparatus, produce an apparatus for implementing functionalities/acts specified in one or more blocks in the flowcharts and/or block diagrams. These computer-readable program instructions may also be stored in a computer-readable storage medium, and these instructions cause the computer, the programmable data processing apparatus, and/or other devices to work in a specific manner. Thus, the computer-readable medium having instructions stored thereon includes an article of manufacture including instructions for implementing various aspects of the functionalities/acts specified in one or more blocks in the flowcharts and/or block diagrams.

The computer-readable program instructions may be loaded onto a computer, other programmable data processing apparatus, or other device, causing a series of operational steps to be performed on the computer, other programmable data processing apparatus, or other device to produce a computer-implemented process, such that the instructions executed on the computer, other programmable data processing apparatus, or other device implement the functionalities/acts specified in one or more blocks in the flowcharts and/or block diagrams.

The flowcharts and block diagrams in the drawings illustrate the architecture, functionality, and operation of possible implementations of systems, methods, and computer program products according to multiple implementations of the present disclosure. In this regard, each block in the flowcharts or block diagrams may represent a module, a program segment, or a portion of instructions, and the module, the program segment, or the portion of instructions contains one or more executable instructions for implementing specified logical functionalities. In some alternative implementations, the functionalities noted in the blocks may also occur out of the order noted in the drawings. For example, two successive blocks may, in fact, be executed substantially concurrently, or the blocks may sometimes be executed in a reverse order, depending upon the functionality involved. It is also noted that each block of the block diagrams and/or flowcharts and combinations of blocks in the block diagrams and/or flowcharts may be implemented by special-purpose hardware-based systems that perform the specified functionalities or acts, or combinations of special-purpose hardware and computer instructions.

The implementations of the present disclosure have been described above, and the above description is exemplary, not exhaustive, and is not limited to the disclosed implementations. Many modifications and variations will be apparent to those of ordinary skill in the art without departing from the scope and spirit of the described implementations. The terminology used herein is chosen to best explain the principles of the implementations, the practical application, or improvements to the technology in the marketplace, or to enable others of ordinary skill in the art to understand the implementations disclosed herein.

1. A method for task execution, comprising:
determining a task to be executed based on a user intent identified from a user input;
determining a set of functional blocks based on a plurality of functional blocks and a data flow associated with the task; and
executing the task using the combined set of functional blocks.

2. The method of claim 1, wherein determining the set of functional blocks comprises:
determining, from the plurality of functional blocks, functional blocks matching the task as at least a part of the set of functional blocks based on respective description information of the plurality of functional blocks, description information of a functional block at least comprising a semantic description of a functionality of the functional block.

3. The method of claim 2, wherein determining the functional blocks matching the task comprises:
generating a prompt input based on the respective description information of the plurality of functional blocks and the user input;
providing the prompt input to a model; and
obtaining, from the model, an indicator of the functional blocks matching the task.

4. The method of claim 3, further comprising:
providing, in response to determining that the functional blocks matching the task comprise a plurality of candidate modules for executing at least part of the task, prompt of the plurality of candidate modules to the user; and
removing, from the functional blocks matching the task, candidate modules other than a first candidate module based on a selection of the first candidate module by the user from the plurality of candidate modules.

5. The method of claim 1, further comprising:
determining an order of the set of functional blocks based on the data flow; and
combining the set of functional blocks according to the order.

6. The method of claim 5, wherein determining the order of the set of functional blocks comprises:
determining an endpoint functional block of the set of functional blocks based on endpoint data in the data flow, the endpoint data comprising at least one of the following in the data flow:
input data, output data, and the endpoint functional block comprising at least any of the following in the set of functional blocks: a start module, an end module.

7. The method of claim 6, wherein determining the order of the set of functional blocks further comprises:
determining, from the set of functional blocks, an adjacent functional block adjacent to the endpoint functional block based on the interface data of the endpoint functional block, the endpoint functional block and the adjacent functional block communicate via the interface data, and the adjacent functional block comprises at least one of the following of the endpoint functional block: a predecessor module, a successor module.

8. The method of claim 5, wherein combining the set of functional blocks according to the order comprises:
combining a first functional block and a second functional block in the set of functional blocks in response to determining that a first format of output data of the first functional block is consistent with a second format of input data of the second functional block, the first functional block and the second functional block being adjacent functional blocks arranged in the order.

9. The method of claim 8, further comprising: adding the combined first functional block and second functional block to a cache of a functional block library comprising the plurality of functional blocks to form a third functional block, input data of the third functional block being the same as the input data of the first functional block, and output data of the third functional block being the same as the input data of the second functional block.

10. The method of claim 9, further comprising: in response to determining that the first format and the second format are inconsistent,
converting the first format to the second format using a conversion module; and
combining the first functional block, the conversion module, and the second functional block.

11. The method of claim 8, further comprising: adding the conversion module to a functional block library comprising the plurality of functional blocks.

12. The method of claim 8, wherein the conversion module is obtained based on at least any of the following:
a functional block customized based on the first format and the second format;
a third-party functional block obtained based on the first format and the second format.

13. The method of claim 1, further comprising: creating, in response to determining that the plurality of functional blocks cannot execute at least part of the task, a functional block for executing the at least part of the task based on at least any of the following:
rewriting a functional block in the plurality of functional blocks; and
creating a new functional block different from the plurality of functional blocks.

14. The method of claim 1, further comprising:
receiving another user input represented in a natural language from a user;
parsing the another user input to determine another task to be executed; and
executing, in response to determining that the task and the another task are of a same type, the another task using the combined set of functional blocks.

15. The method of claim 1, further comprising:
generating an application using the combined set of functional blocks; and
adding the application to a functional block library comprising the plurality of functional blocks.

16. The method of claim 15, wherein generating the application comprises: generating the application in response to a preset condition being satisfied.

17. The method of claim 16, further comprising determining that the preset condition is satisfied in response to at least any of the following:
a number of executions of the task exceeds a threshold number;
a frequency of executions of the task exceeds a threshold frequency;
an application generation instruction is received from a user.

18. (canceled)

19. (canceled)

20. (canceled)

21. (canceled)

22. (canceled)

23. A method for task processing, comprising:
determining a task to be executed based on a user intent identified from a user input;
executing the task using a set of functional blocks provided by a low-code platform; and
generating an application for executing the task based on the set of functional blocks in response to a preset condition being satisfied.

24. The method of claim 23, further comprising:
determining that the preset condition is satisfied in response to at least any of the following:
a number of executions of the task exceeds a threshold number;
a frequency of executions of the task exceeds a threshold frequency;
an application generation instruction is received from a user; and
adding the application to a functional block library comprising a plurality of functional blocks.

25. (canceled)

26. (canceled)

27. A device for task processing, comprising:
at least one processor; and
at least one memory coupled to the at least one processor and storing instructions for execution by the at least one processor, the instructions, when executed by the at least one processor, causing the device to perform operations comprising:
determining a task to be executed based on a user intent identified from a user input;
determining a set of functional blocks based on a plurality of functional blocks and a data flow associated with the task; and
executing the task using the combined set of functional blocks.

28. (canceled)
